(19) United States
(12) Patent Application Publication
(10) Pub. No.: US 2004/0183310 A1
(43) Pub. Date: Sep. 23, 2004

(54) Mowll-Bernoulli wind power generator

(76) Inventor: Jack Mowll, Baltimore, MD (US)

Correspondence Address: Royal W. Craig, Law Offices of Royal W. Craig, Suite 153, 10 N. Calvert Street, Baltimore, MD, 21202, US

(21) Appl. No.: 10/805,098

(22) Filed: Mar. 19, 2004

Related U.S. Application Data
(60) Provisional application No. 60/456,109, filed on Mar. 19, 2003.

(51) Int. Cl. H02P 9/04

(52) U.S. Cl. 290/55; 290/1 R

(57) ABSTRACT

A wind power generator. The apparatus comprises a vortex housing with a large frontal opening at one end and a smaller exhaust opening at another end. The housing further has a concave internal surface leading rearward to the exhaust opening and an exhaust channel. A propeller-driven electrical generator is mounted inside the exhaust channel for generating electrical power from the wind. The apparatus is mounted atop a vertical-axis base for free pivotal movement, and a plurality of air-foil fins are mounted toward the rear of the housing to continuously maintain the frontal opening of the apparatus facing the wind. Based upon Bernoulli's principle, wind entering the frontal opening increases in velocity as it is constricted towards the exhaust opening and channel. Thus, a high velocity wind is created for passing over and turning the generator's propellers and thereby increasing the rotation speed of the propellers.

### CROSS-REFERENCE TO RELATED APPLICATIONS

The present application derives priority from U.S. Provisional Patent Application No. 60/456,109 for “JAMO-BERNOULLI WIND POWER GENERATOR”; Filed: Mar. 19, 2003; Inventor: Jack Mowll.

### BACKGROUND OF THE INVENTION

1. Field of the Invention

The present invention relates to electricity generation and, more particularly, to a device that employs the Bernoulli principle for converting fluid flow to power.

2. Description of the Background

There are a variety of existing systems that generate AC power by rotational action, employing a windmill or turbine-like blades for driving a generator. Wind energy is clean, non-polluting, energy. Unlike conventional power plants, wind plants emit no air pollutants or greenhouse gases. Moreover, the wind is a free and limitless resource.

Unfortunately, there are tremendous obstacles to greater wind power usage. Even though the cost of wind power has decreased, it is still much higher than fossil-fueled generators. One reason for this has been a relatively low efficiency. The efficiency of most existing wind generators is from 35% to 57%.

The traditional approach for electrical generation using wind energy is to connect the wind turbine axis to the axis of an electrical generator. Modem electrical generators have an efficiency value around 85%. Thus, existing blade configurations and/or wind collection vanes could be far more efficient.

It is well-known that Bernoulli's principle states that as the pressure of a flowing fluid (liquid or gas) rises, the speed of the fluid falls. Conversely, if there is a decrease in fluid pressure, the speed of the fluid increases. Air plane wings are designed, using Bernoulli's principle, with curved, tapering upper surfaces, to increase air speed over the top of the wing, thereby reducing air pressure and creating lift. Similarly, a venturi tube which is narrower in the middle than it is at its ends, acts on this same principle such that fluid entering the venturi tube increases in velocity as it reaches the narrow part of the tube.

It would be advantageous over the prior art wind power generators to use this same principle (Bernoulli's principle) to control the speed of fluid flow past electrical turbines of a generator in order to improve power production efficiency. Indeed, the speed of the turbines can be increased by the speed of the fluid, thereby enhancing the efficient utilization of the wind (or other fluid) energy by the generator.

### SUMMARY OF THE INVENTION

It is, therefore, an object of the present invention to provide an efficient power generation system that produces supplemental electricity at no operating cost, with minimal capital outlay, to reduce consumption of scarce, irreplaceable, fossil fuels.

It is another object to provide an efficient power generation system which relies on the Bernoulli principle to improve efficiency by increasing the wind velocity past a generator.

According to the present invention, the above-described and other objects are accomplished by providing an electricity-generating device using wind power, based on Bernoulli's principle. The power generating apparatus comprises a vortex housing with a large frontal opening at one end and a smaller opening leading to an exhaust channel at another end. The vortex housing has a concave internal surface leading rearward to the exhaust channel. Wind enters the vortex housing at the frontal end and passes through the exhaust channel. A propeller-drive electrical generator is mounted inside the exhaust opening for generating electrical power from the wind passing there through. The apparatus is mounted atop a vertical-axis base for free pivotally movement, and a plurality of air-foil fins are mounted toward the rear of the housing to maintain it facing the wind. The concave shape of the vortex housing of the wind power generating apparatus employs Bernoulli's principle to induce a decrease in pressure and thus an increase in the velocity of the wind as it passes from the front of the vortex housing into the exhaust channel and over the propeller of the generator. Thus, when the wind enters the exhaust opening it will have obtained maximum velocity, faster wind increases the rate of rotation of the propeller and thereby increases electricity production of the generator.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a side view illustration of a Mowll-Bernoulli wind power generator 2 according to the present invention.

FIG. 2 is a front view illustration of the Mowll-Bernoulii wind power generator 2 according to the present invention.

### DETAILED DESCRIPTION OF THE PREFERRED EMBODIMENTS

The apparatus of the present invention is a fluid flow power generating device and is described herein with respect to air or wind flow power. However, those skilled in the art will recognize that a similar apparatus may be used to generate power from the flow of other fluids, including water.

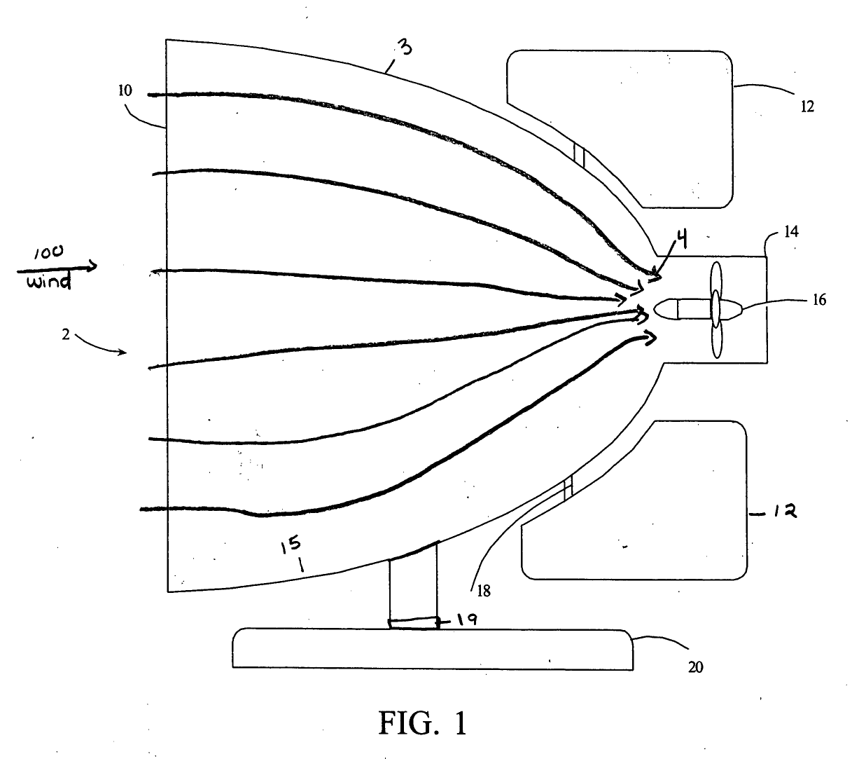

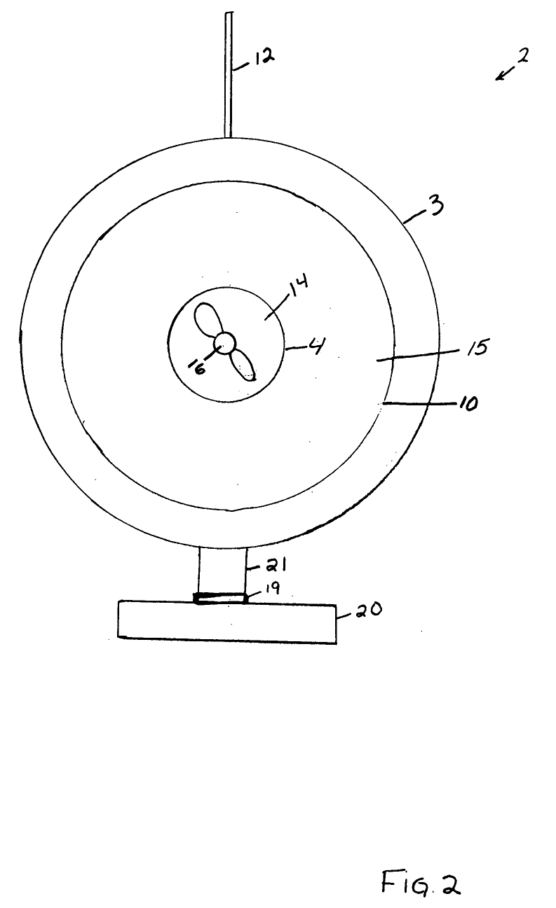

Referring now to FIGS. 1 and 2 in combination, there is shown a wind flow power generating apparatus 2 according to the present invention. The apparatus 2 includes a vortex housing 3 with a large frontal opening 10 at one end and a smaller exhaust opening 4. Extending from the exhaust opening 4 is a hollow cylindrical exhaust channel 14. The vortex housing 3 is essentially semi-oval shaped with a concave internal surface tapering rearward from the frontal opening 10 to the exhaust opening 4.

A propeller-driven electrical generator 16 is mounted inside the exhaust channel 14 for generating electrical power from wind 100 passing over its propellers, causing them to turn. The propeller-drive generator 16 is preferably a high-wind-velocity model, of which a variety are commercially available. For example, the Air® Industrial Wind Generator is well suited because it is capable of resisting a harsh environments, such as high-wind mountaintop platforms. The higher the velocity of the wind that passes over the propellers, the faster the propellers turn and the greater the amount of electricity produced.

A plurality of fins 12 (i.e. air foils) are fixed on posts 18 toward the rear of the housing 3 and are aligned with the longitudinal axis of the housing 3, perpendicular to and centered on opening 10. The vortex housing 3 is mounted atop or integrally formed with a vertical-axis pedestal 21 and base 20. Either the pedestal 21 is pivotally mounted 19 to the base 20 or the housing 3 is pivotally mounted to the pedestal 21, such that the air-foil fins 12 are able to continuously maintain the housing 3 facing the wind 100.

The wind power generating apparatus 2 is based on Bernoulli's principle. Specifically, as the wind 100 enters the frontal opening 10 and encounters the concave internal surface 15 it passes rearward to the exhaust opening 4. The constricting shape works as if it were a venturi tube, thus creating a decrease in pressure but an increase in the velocity of the wind 100 as it enters the exhaust channel 14. As the wind 100 enters the exhaust channel 14 it will have obtained a maximum velocity. The wind 100 with increased velocity will in turn increase the propeller speed on the propeller-drive electrical generator 16 to maximum rpms. This will produce clean and abundant electrical power at no operating cost, with minimal capital cost, to reduce consumption of scarce, irreplaceable, fossil fuels.

The wind power generating apparatus 2 is intended for installation in areas with constant winds. Examples of such areas include (1) high elevations such as the proposed replacements for the World Trade Towers in New York, a mountaintop, or any high natural elevations where there is an up-draft/down-draft (“Chinook Wind”), or (2) locations near the seashore where relatively constant on-shore/off-shore winds are available. The wind power generating apparatus 2 may also be mounted on the guide-way supporting structures set forth in the “Surrey System” mode of transport of U.S. Pat. No. 4,791,871 issued to the present inventor.

The power delivered by the wind power generating apparatus 2 will be determined by the size of the housing 3, including the diameters of the frontal and exhaust openings 10, 3 and the depth of the housing, as well as the initial wind velocity. For example, a wind power generating apparatus 2 comprised of a 40′ housing with wind speeds of 8 to 30 miles per hour and a with a 30 kw generator 16 could generate as much as 1200 kw. Thus, the wind power generating apparatus 2 is an excellent source of supplemental power. Placing a plurality of wind power generating apparatuses 2 in a circuit could viably supply a small city with its entire power requirements.

While the foregoing description has primarily focused on a wind power generating system, the concept is equally adaptable to other fluid-based (i.e. water) locations as well. Efficient hydro power generation may be achieved utilizing the same principle.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. A power generating apparatus, comprising:
a vortex housing with a large frontal opening at one end and a smaller exhaust opening at another end leading to an exhaust channel, said housing further comprising a concave internal surface leading rearward to the exhaust opening for channeling fluid there through;
a propeller-drive electrical generator mounted inside the exhaust channel for generating electrical power from the rotation of the propellers caused by the flow of said fluid;
a vertical-axis pedestal and base for pivotally mounting said vortex housing;
a plurality of fins mounted toward the rear of said housing to continuously maintain the is frontal opening of the power generating apparatus in a position facing incoming fluid;
whereby the power generating apparatus employs Bernoulli's principle to induce an increase fluid velocity as the fluid passes from the frontal opening to the exhaust opening, such that when the fluid enters the exhaust opening it will have obtained a maximum velocity to turn the propeller-drive electrical generator.

2. The apparatus according to claim 1, whereby the power delivered by said apparatus is determined by the size of the housing (including the diameters of the frontal and exhaust openings and the depth of the housing) and the velocity of the wind as it enter the frontal opening.

3. The apparatus according to claim 1, wherein said fluid is gas, such as wind.

4. The apparatus according to claim 3, wherein said generator is a high-wind-velocity type generator capable of resisting harsh environments.

5. The apparatus according to claim 3, wherein said fins are airfoils fixed on posts to said housing and aligned perpendicular to and centered on the frontal opening.

6. The apparatus according to claim 3, whereby said apparatus is installed in a location subject to constant winds, including high elevation and seashore areas.

7. The apparatus according to claim 1, wherein said fluid is liquid, such as water.

8. A method for operating the apparatus of claim 1, whereby a plurality of said apparatuses are connected in a circuit in order to combine the power generating capabilities of the individual apparatuses.
